(19) United States
(12) Patent Application Publication
(10) Pub. No.: US 2026/0333042 A1
(43) Pub. Date: Oct. 22, 2026

(54) PRE-SHARED KEY AUTHENTICATION FOR WIRELESS COMMUNICATIONS

(71) Applicant: Lenovo (United States) Inc., Morrisville, NC (US)

(72) Inventors: Andreas Kunz, Ladenburg (DE); Sheeba Backia Mary Baskaran, Friedrichsdorf (DE)

(73) Assignee: Lenovo (United States) Inc., Morrisville, NC (US)

(21) Appl. No.: 19/390,239

(22) Filed: Nov. 14, 2025

(51) Int. Cl. H04W 12/069; H04W 12/75; H04W 76/10

(52) U.S. Cl. CPC H04W 12/069; H04W 12/75; H04W 76/10

(57) ABSTRACT

Various aspects of the present disclosure relate to pre-shared key authentication for wireless communications. A user equipment (UE) communicates, to a first network function, a session request message including a support indication. The support indication indicates access traffic steering, switching, and splitting (ATSSS) capability with pre-shared key (PSK) support. The first network function communicates, to a second network function, a request message including a temporary identifier, the support indication, and a security key. The first network function receives, from the second network function and in response to the request message, a response message including an acceptance indication based on the support indication. The acceptance indication indicates PSK-based authentication or certificate-based authentication for the requested session. The first network function communicates the acceptance indication to the UE. The UE establishes a secure connection with the second network function according to the acceptance indication.

### TECHNICAL FIELD

The present disclosure relates to wireless communications, and more specifically to security mechanisms for multi-access network sessions.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to communicate, to a network function, a session request message including a session identifier, a request type, and a support indication, receive, from the network function, a response message including an acceptance indication, and establish a secure connection with a user plane function (UPF) based on the acceptance indication.

A processor for wireless communication is described. The processor may be configured to, capable of, or operable to perform one or more operations as described herein. For example, the processor may be configured to, capable of, or operable to communicate, to a network function, a session request message including a session identifier, a request type, and a support indication, receive, from the network function, a response message including an acceptance indication, and establish a secure connection with a UPF based on the acceptance indication.

A method performed or performable by a UE for wireless communication is described. The method may include communicating, to a network function, a session request message including a session identifier, a request type, and a support indication, receiving, from the network function, a response message including an acceptance indication, and establishing a secure connection with a UPF based on the acceptance indication.

In some implementations of the UE, the processor, and the method described herein, the support indication indicates access traffic steering, switching and splitting (ATSSS) capability with pre-shared key (PSK) support. In some implementations of the UE, the processor, and the method described herein, the at least one processor is further operable to cause the UE to derive a security key prior to communicating the session request message or in response to receiving the response message. In some implementations of the UE, the processor, and the method described herein, to establish the secure connection with the UPF, the at least one processor is further operable to cause the UE to perform a transport layer security (TLS) handshake and authentication procedure with the UPF using the security key and a temporary identifier, where the temporary identifier is a globally unique temporary identifier (GUTI) or a generic public subscription identifier (GPSI). In some implementations of the UE, the processor, and the method described herein, the security key is a pre-shared key.

An NE for wireless communication is described. The NE may be configured to, capable of, or operable to perform one or more operations as described herein. For example, the NE may be configured to, capable of, or operable to receive, from a UE, a first request message including a session identifier, a request type, and a support indication, derive, in response to receiving the support indication, a security key, communicate, to a network function, a second request message including a temporary identifier, the support indication, and the security key, receive, from the network function, a first response message including an acceptance indication, and communicate, to the UE, a second response message including the acceptance indication.

A processor for wireless communication is described. The processor may be configured to, capable of, or operable to perform one or more operations as described herein. For example, the processor may be configured to, capable of, or operable to receive, from a UE, a first request message including a session identifier, a request type, and a support indication, derive, in response to receiving the support indication, a security key, communicate, to a network function, a second request message including a temporary identifier, the support indication, and the security key, receive, from the network function, a first response message including an acceptance indication, and communicate, to the UE, a second response message including the acceptance indication.

A method performed or performable by an NE for wireless communication is described. The method may include receiving, from a UE, a first request message including a session identifier, a request type, and a support indication, deriving, in response to receiving the support indication, a security key, communicating, to a network function, a second request message including a temporary identifier, the support indication, and the security key, receiving, from the network function, a first response message including an acceptance indication, and communicating, to the UE, a second response message including the acceptance indication.

In some implementations of the NE, the processor, and the method described herein, the support indication indicates ATSSS capability with PSK support. In some implementations of the NE, the processor, and the method described herein, the acceptance indication indicates PSK-based authentication or certificate-based authentication. In some implementations of the NE, the processor, and the method described herein, the first request message is for a protocol data unit (PDU) session, the request type is a multi-access (MA) PDU request type, the security key is a UPF security key, the network function is a session management function (SMF), and the temporary identifier is a GUTI or a GPSI.

In some implementations of the NE, the processor, and the method described herein, the first request message is received as part of a PDU session establishment procedure for establishing a multi-access PDU session supporting ATSSS. In some implementations of the NE, the processor, and the method described herein, to derive the security key, the at least one processor is further operable to cause the NE to use a key derivation function (KDF) with input parameters including at least one of a PDU session identifier, a non-access stratum (NAS) uplink COUNT value, an MA PDU session identifier, an internet protocol (IP) address of the MA PDU session, a subscription permanent identifier (SUPI), a subscription concealed identifier (SUCI), a GUTI, a GPSI, an access and mobility management function (AMF) key, or a security anchor function (SEAF) key.

An NE for wireless communication is described. The NE may be configured to, capable of, or operable to perform one or more operations as described herein. For example, the NE may be configured to, capable of, or operable to receive, from a first network function, a first request message including a temporary identifier, a support indication, and a security key, communicate, to a second network function, a second request message including the temporary identifier, the support indication, and the security key, receive, from the second network function and in response to the second request message, a first response message including an acceptance indication, and communicate, to the first network function, a second response message including the acceptance indication.

A processor for wireless communication is described. The processor may be configured to, capable of, or operable to perform one or more operations as described herein. For example, the processor may be configured to, capable of, or operable to receive, from a first network function, a first request message including a temporary identifier, a support indication, and a security key, communicate, to a second network function, a second request message including the temporary identifier, the support indication, and the security key, receive, from the second network function and in response to the second request message, a first response message including an acceptance indication, and communicate, to the first network function, a second response message including the acceptance indication.

A method performed or performable by an NE for wireless communication is described. The method may include receiving, from a first network function, a first request message including a temporary identifier, a support indication, and a security key, communicating, to a second network function, a second request message including the temporary identifier, the support indication, and the security key, receiving, from the second network function and in response to the second request message, a first response message including an acceptance indication, and communicating, to the first network function, a second response message including the acceptance indication.

In some implementations of the NE, the processor, and the method described herein, the support indication indicates ATSSS capability with PSK support. In some implementations of the NE, the processor, and the method described herein, the at least one processor is further operable to cause the NE to select the second network function based on the second network function being an ATSSS-enabled UPF that supports PSK. In some implementations of the NE, the processor, and the method described herein, the acceptance indication indicates PSK-based authentication or certificate-based authentication. In some implementations of the NE, the processor, and the method described herein, the first network function is an AMF, the second network function is a UPF, the security key is a UPF security key, and the temporary identifier is a GUTI or a GPSI.

In some implementations of the NE, the processor, and the method described herein, the second request message is an N4 session establishment request. In some implementations of the NE, the processor, and the method described herein, the temporary identifier, the support indication, and the security key are received as part of a PDU session establishment procedure for a multi-access PDU session. In some implementations of the NE, the processor, and the method described herein, the at least one processor is further operable to cause the NE to activate multipath quick user datagram protocol (UDP) internet connections (MPQUIC) functionality and derive ATSSS rules and N4 rules for PDU session management.

### BRIEF DESCRIPTION OF THE DRAWINGS

FIG. 1 illustrates an example of a wireless communications system in accordance with aspects of the present disclosure.

FIG. 2 illustrates an example of MA PDU session establishment, in accordance with aspects of the present disclosure.

FIG. 3 illustrates an example of a UE in accordance with aspects of the present disclosure.

FIG. 4 illustrates an example of a processor in accordance with aspects of the present disclosure.

FIG. 5 illustrates an example of an NE in accordance with aspects of the present disclosure.

FIG. 6 illustrates a flowchart of a method performed by a UE in accordance with aspects of the present disclosure.

FIGS. 7 and 8 illustrate flowcharts of methods performed by an NE in accordance with aspects of the present disclosure.

### DETAILED DESCRIPTION

A wireless communications system may support wireless communications for one or more devices (e.g., UEs and NEs, among other examples) that transmit and/or receive signaling via an over-the-air interface (e.g., as part of a radio access network (RAN)). In some examples, a device may be capable of supporting multiple access networks, such as 5G or beyond and Wi-Fi. For example, ATSSS is a feature that enables a device to simultaneously utilize a 3rd Generation Partnership Project (3GPP) network (e.g., 5G, 4G) and a non-3GPP network (e.g., Wi-Fi) for a single data session (e.g., an MA PDU) session). The device can steer traffic of a data flow to one of the networks, switch traffic of a data flow from one network to another without service interruption, and split traffic of a data flow to use both networks simultaneously. ATSSS steering modes and steering functionalities (ATSSS-ST) define how the traffic is distributed between the different networks, and are applicable to different protocols (e.g., IP, Ethernet, UDP). Some wireless communications support MPQUIC steering functionality for UDP packets.

In 5G network architectures, the AMF handles UE registration and mobility management, the SMF manages PDU sessions and coordinates with user plane functions, and the UPF handles user data packet routing and forwarding. Network functions such as the AMF, the SMF, the UPF, and the like, among other examples, may implement or be implemented by one or more NEs. When establishing an MA PDU session with ATSSS capabilities, secure authentication between a UE and UPF may be required for protocols such as MPQUIC that enable simultaneous data transmission over multiple network paths. Conventional techniques rely on certificate-based authentication methods. However, certificate-based approaches may rely on relatively complex certificate management infrastructure and validation procedures, which can introduce computational overhead during connection establishment and may require additional network resources for certificate storage and distribution. Moreover, certificate-based authentication may not be optimal for scenarios where simplified security mechanisms are preferred, such as in resource-constrained environments or when rapid session establishment is desired. PSK authentication may provide more flexible deployments, particularly for MPQUIC over TLS connections. However, conventional techniques may not provide efficient mechanisms for distributing and managing PSKs within existing 5G security architectures.

The described techniques provide for establishing secure multi-access PDU sessions using PSK authentication mechanisms integrated within existing 5G security architectures. For example, according to the present disclosure, during MA PDU session establishment a UE may derive a security key and communicate support indications for ATSSS capabilities with PSK authentication to network functions (e.g., AMF, SMF, UPF). For instance, the UE may transmit a PDU session establishment request message including an indication of PSK support. In response to receiving the indication, the AMF may be triggered to derive the same security key and coordinate with the SMF to select an appropriate UPF that supports the indicated PSK authentication capabilities. The UPF may indicate, to the UE (e.g., via the AMF and the SMF), that the PDU session with PSK support is accepted. Alternatively, if the UPF refrains from supporting PSK, the UPF can indicate that the PDU session is accepted with certificate-based authentication. The techniques described herein further provide methods and systems for distributing security keys and temporary identifiers across network functions to enable secure PSK-based MPQUIC connections. For example, the SMF may forward the derived security key and temporary identifier to the selected UPF, which stores these parameters for subsequent authentication procedures. Based on acceptance indications from the UPF, the UE may establish a secure TLS connection using the derived security key as a PSK along with the temporary identifier.

The techniques described herein improve the efficiency and security of wireless communications by providing streamlined authentication mechanisms within existing 5G security infrastructure. For example, PSK-based authentication as described herein enables UEs to establish secure connections with reduced computational overhead compared to certificate-based approaches. A UE utilizing PSK authentication can achieve faster connection establishment and reduced authentication latency, leading to improved session setup times. The described techniques further enhance network flexibility by supporting both PSK and certificate-based authentication methods, as well as by maintaining backward compatibility with legacy systems while enabling enhanced security features for capable devices. Additionally, optimizing secure MPQUIC establishment between UEs and UPFs may improve the performance and reliability of ATSSS-enabled multi-access sessions, enabling more efficient utilization of multiple network paths simultaneously.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

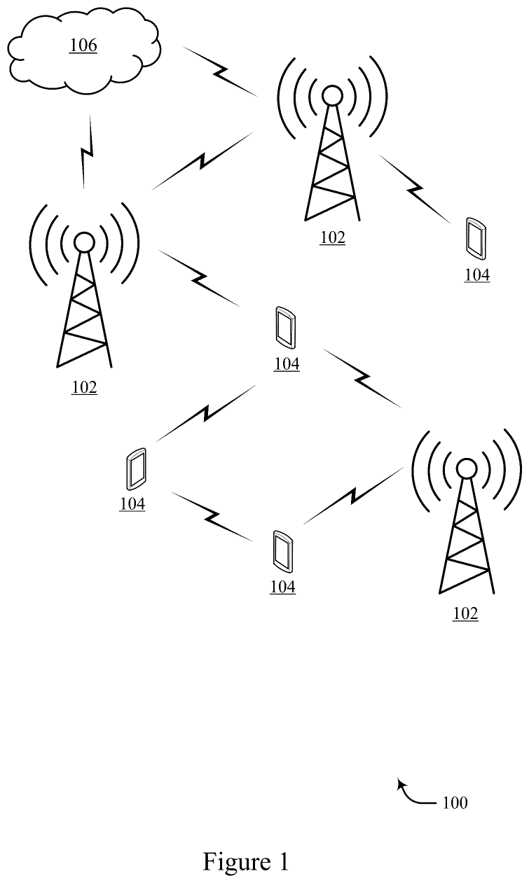

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In one or more implementations, a UE 104 may request establishment of an MA PDU session that supports ATSSS functionality and PSK-based authentication. The UE 104 may communicate a PDU session establishment request to the CN 106 (e.g., via an NE 102), where the request includes a support indication for ATSSS capability with PSK authentication. The support indication may be transmitted as part of protocol configuration options or within other signaling parameters of the session establishment procedure. Upon receiving the support indication, network functions within the CN 106 and/or within one or more NEs 102 may coordinate to establish the requested session with appropriate security mechanisms. For example, an AMF may derive a security key in response to the support indication and communicate session parameters including the security key and a temporary identifier to an SMF. The SMF may select a UPF based on the UPF's capability to support PSK authentication for the requested ATSSS session.

The selected UPF may receive the security key and temporary identifier from the SMF and store these parameters for subsequent authentication procedures with the UE 104. The UPF may communicate an acceptance indication back through the network functions to inform the UE 104 whether PSK-based authentication or certificate-based authentication will be used for the session. Based on the acceptance indication, the UE 104 may establish a secure connection with the UPF using the appropriate authentication method. In implementations where PSK authentication is supported, the UE 104 may perform a TLS handshake with the UPF using the derived security key as a pre-shared key and the temporary identifier for authentication. This approach enables the UE 104 to establish secure MPQUIC connections for multi-access data transmission while leveraging existing 5G security infrastructure and maintaining compatibility with conventional certificate-based authentication methods.

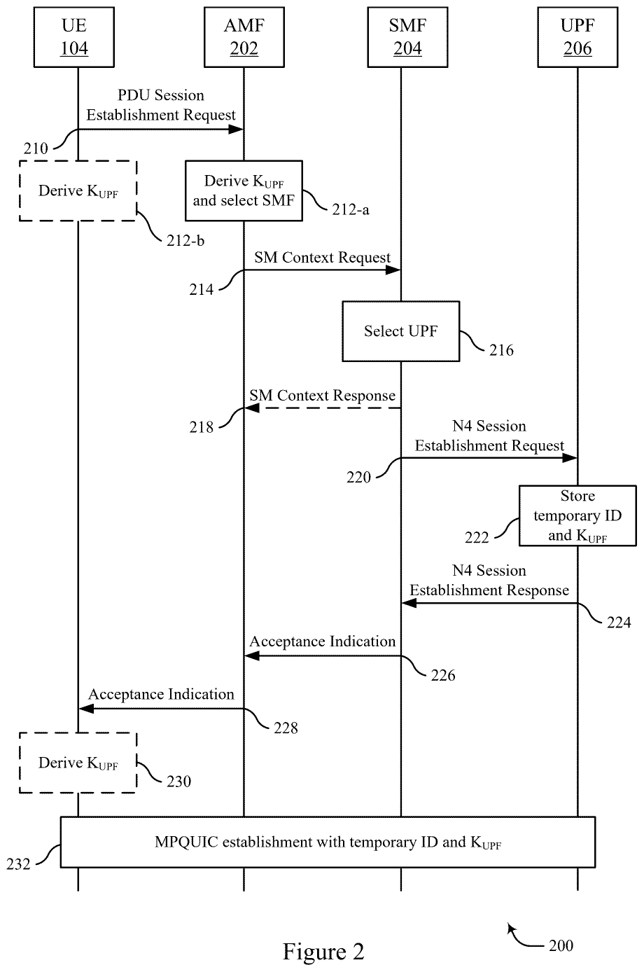

FIG. 2 illustrates an example 200 of MA PDU session establishment in accordance with aspects of the present disclosure. In particular, FIG. 2 illustrates a procedure for UE-requested MA PDU session establishment between a UE 104 and a network, where the UE 104 indicates its support for PSK-based authentication. The example 200 illustrates a UE 104, an AMF 202, an SMF 204, and a UPF 206, which may be include or examples of corresponding devices as described with reference to FIG. 1. While the operations of the example 200 are illustrated in the context of a 5G network, it is to be understood that the techniques described herein are applicable to any type of network or combination of networks.

To establish an MA PDU session, the UE 104 constructs a request message, such as an UL NAS message for PDU session establishment procedures (e.g., a PDU session establishment request message). The request message can include an indication of a session type (e.g., an MA PDU session type) requested by the UE 104, a PDU session identifier, and an indication (e.g., an explicit indication) that the UE 104 supports PSK for MA PDU sessions (referred to herein as a support indication). In some examples, the support indication includes or is part of an explicit indication that the UE supports ATSSS capabilities.

The support indication may be transmitted as part of protocol configuration options or within other signaling parameters of the session establishment procedure. For example, the support indication can be specified in a new information element, part of an existing information element such as a 5GSM capability information element, an existing container for protocol configuration options (PCO) parameters, or a new container for PCO parameters, among other examples. In some implementations, the indication may be implemented as a bit flag within existing capability structures to minimize signaling overhead, or as an enumerated value that specifies authentication method preferences such as PSK-preferred, certificate-preferred, or PSK-only. Additionally, or alternatively, the indication may also be combined with ATSSS steering functionality indications, such as in a composite field that specifies both MPQUIC capability and PSK support in a single parameter.

At 210, the UE 104 initiates (e.g., communicates, transmits, sends) the request message including the support indication to the AMF 202. The session establishment request at 210 notifies the CN 106 (e.g., the AMF 202) that the UE 104 is requesting to establish an MA PDU session.

At 212-a, upon reception of (e.g., based on, in response to) the request message including the support indication, the AMF 202 derives a security key. The support indication and/or reception of the support indication (e.g., of a PDU session establishment request message including a support indication) may serve as a trigger for the AMF 202 to derive the security key. The security key may include or be an example of a UPF security key K_{UPF}. To derive the security key, the AMF 202 may use a key derivation function with input parameters that include a base key such as K_{AMF} (access and mobility management function key) or K_{SEAF} (security anchor function key) and one or more additional parameters, such as a PDU session identifier, a non-access stratum (NAS) uplink COUNT value (e.g., a security parameter used for replay protection), an MA PDU session identifier, an IP address of the MA PDU session, a subscription permanent identifier (SUPI), a subscription concealed identifier (SUCI), a GUTI, or a GPSI, among other examples.

Additionally, at 212-a, the AMF 202 determines an SMF 204 to create a session management (SM) context based on the request message received from the UE 104. For instance, the AMF 202 can select an SMF 204 that supports the ATSSS and MA PDU sessions.

At 212-b, in some examples, the UE 104 may also derive the security key (e.g., K_{UPF}). Alternatively, the UE 104 may derive the security key prior to communicating the session establishment request message (e.g., prior to 210) or when receiving an MA PDU session accept message (e.g., at 230). The UE 104 derives the security key using the key derivation function and the one or more parameters used by the AMF 202 to derive the security key.

At 214, the AMF 202 constructs and communicates (e.g., transmits, sends), to the determined SMF 204, a request to generate an SM context. The request to generate the SM context provides the SMF 204 with the appropriate data, information, etc. to establish a SM context for the requested MA PDU session. The request to generate the SM context is, for example, an Nsmf_PDUSession_CreateSMContext request that indicates the MA PDU session and includes the support indication (e.g., indicating ATSSS capabilities with PSK support), the security key (e.g., derived at 212-a), and the PDU session identifier. The request may further include a temporary identifier associated with the UE 104. For example, the AMF 202 may obtain (e.g., receive, identify, determine) a temporary ID associated with the UE 104, such as a GUTI or a GPSI, from existing PDU session establishment signaling (e.g., session management context creation, NAS signaling procedures, etc.) and may include the temporary ID in the request to generate the SM context. By leveraging an existing identifier rather than generating a new parameter, the necessary identity component for PSK-based authentication can be acquired without increased signaling overhead or resource consumption.

At 216, upon reception of the request to generate the SM context from the AMF 202, the SMF 204 determines whether the MA PDU session is allowed or not based on operator policy and subscription data. Additionally, at 216, based on the support indication, the SMF selects an ATSSS-enabled UPF (e.g., the UPF 206) that supports PSK. The SMF 204 creates an SM context according to the SM context request from the AMF 202. In one or more implementations, the SMF 204 activates MPQUIC functionality (e.g., based on the received support indication, network policies, and UPF capabilities) and derives ATSSS rules that define how traffic should be steered, switched, or split between different access networks (e.g., 3GPP and non-3GPP) in the uplink direction, which are subsequently provided to the UE 104 for traffic management decisions. The SMF 204 also derives corresponding N4 rules that instruct the selected UPF 206 on how to handle traffic steering, switching, and splitting operations in the downlink direction, enabling coordinated multipath data transmission across multiple network paths.

At 218, upon creating the SM context, the SMF 204 informs the AMF 202 of the SM context ID for the created SM context via an SM context response. For example, the SMF 204 communicates (e.g., transmits, sends), to the AMF 202, a Nsmf_PDUSession_CreateSMContext response, which may include an SM context ID. The SM context ID provides addressing information allocated by the SMF 204 (e.g., to be used for service operations towards the SMF 204 for the requested MA PDU session).

At 220, the SMF 204 communicates (e.g., transmits, sends) a session establishment request to the UPF 206. For example, the SMF 204 initiates an N4 session establishment procedure with the UPF 206 by sending, to the UPF 206, an N4 session establishment request that includes the temporary identifier, the support indication, and the security key indicated by the AMF 202 (e.g., at 214). Additionally, the SMF 204 may include the N4 rules derived by the SMF 204 (e.g., at 216) for the requested MA PDU session to instruct the UPF 206 to activate the MPQUIC functionality for this MA PDU session. This allows the UPF 206 to activate the MPQUIC functionality for the requested MA PDU session.

At 222, the UPF 206 stores the temporary identifier and the security key. The use of GPSI or GUTI as the temporary identifier enables the UPF 206 to correlate incoming authentication attempts with appropriate stored security keys, as these identifiers are already associated with the UE 104 throughout the session establishment process and provide a consistent identity reference across network functions.

At 224, the UPF 206 communicates (e.g., transmits, sends), to the SMF 204, a response to the session establishment request. For example, the UPF 206 may communicate, to the SMF 204, an NF session establishment response including an acceptance indication that the MA PDU session is accepted with either PSK-based authentication or certificate-based authentication (e.g., an MA PDU session accepted with PSK or an MA PDU session accepted with certificate). In scenarios where the UPF 206 supports both PSK-based authentication and certificate-based authentication, the UPF 206 selects the method based on a (preconfigured) policy and indicates the selected method as part of the acceptance indication. For example, the UPF 206 may select certificate-based authentication despite the received PSK support indication and the security key. Here, the UPF 206 includes, in the response, an MA PDU session accepted with certificate indication. Alternatively, if the UPF 206 selects PSK-based authentication based on the support indication received from the UE 104 (e.g., via the AMF 202 and the SMF 204), the UPF 206 includes, in the response, an MA PDU session accepted with PSK indication.

At 226, the SMF 204 communicates (e.g., transmits, sends), to the AMF 202 in response to the SM context request message, an indication that the requested MA PDU session has been accepted. For example, the SMF 204 includes the acceptance indication from the UPF 206 in a Namf_Communication_N1N2MessageTransfer message to the AMF 202 and indicates to the AMF 202 that the N2 SM Information included in this message should be sent to the UE 104. The acceptance indication indicates the authentication supported or selected by the UPF 206. For example, the acceptance indication may be an MA PDU session accepted with certificate indication or an MA PDU session accepted with PSK indication.

The AMF 202 marks this PDU session as an MA PDU session based on the received acceptance indication. This allows the AMF 202 to notify the UE 104 that the requested MA PDU session has been accepted by the network. At 228, the AMF 202 communicates (e.g., transmits, sends) the response message to the UE 104. For example, at 228, the UE 104 receives a PDU session establishment accept message from the AMF 202, which indicates to UE 104 that the requested MA PDU session was successfully established. This message includes the ATSSS rules for the MA PDU session, which were derived by the SMF 204 at 216. This provides the UE 104 with the information and rules to use to for data flows of the MA PDU session. This message further includes the acceptance indication from the UPF 206 (e.g., via the SMF 204) indicating the authentication supported or selected by the UPF 206. For example, the acceptance indication may be an MA PDU session accepted with certificate indication or an MA PDU session accepted with PSK indication.

At 230, the UE 104 may derive the security key, e.g., based on receiving the MA PDU session accept message from the AMF 202 at 228 and if the UE 104 did not derive the security key at 212-b or prior to 210.

At 232, the UE 104 establishes an MPQUIC connection with the UPF 206 by initiating a TLS handshake and authentication procedure with the UPF 206 according to the authentication method indicated by the acceptance indication (e.g., certificate-based or PSK-based). For example, when the acceptance indication indicates PSK support, the UE 104 uses the security key as a PSK and uses the temporary identifier associated with the UE 104. During this procedure, the UE 104 presents the temporary identifier to identify itself to the UPF 206, which, in turn, correlates the temporary identifier with the stored security key to authenticate the request. The UE 104 follows the ATSSS rules to establish uplink and downlink data flows for the requested MA PDU session. A secure encrypted tunnel is thus established for MPQUIC data transmission between the UE 104 and UPF 206 across multiple network paths.

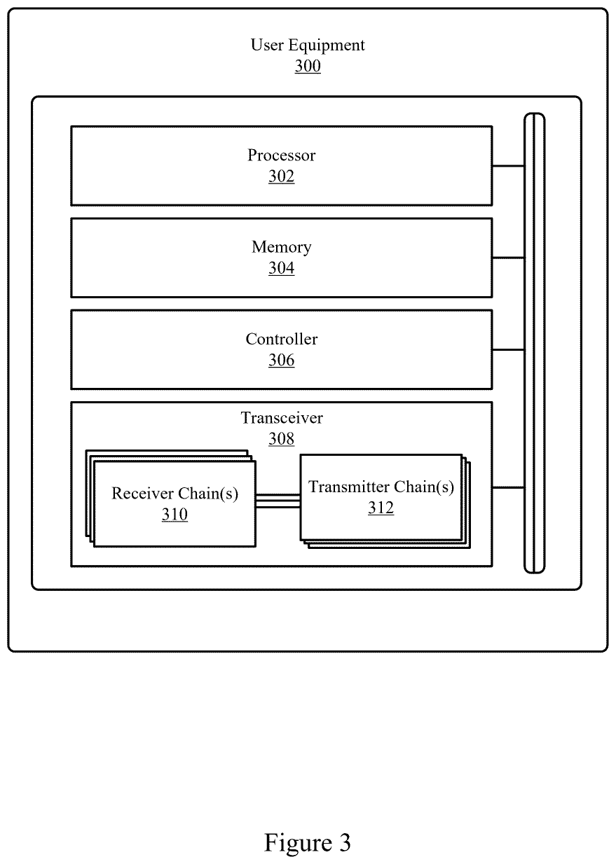

FIG. 3 illustrates an example of a UE 300 in accordance with aspects of the present disclosure. The UE 300 may include a processor 302, a memory 304, a controller 306, and a transceiver 308. The processor 302, the memory 304, the controller 306, or the transceiver 308, or various combinations thereof or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, or the transceiver 308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 302 may include an intelligent hardware device (e.g., a general-purpose processor, a DSP, a central processing unit (CPU), an ASIC, a field-programmable gate-array (FPGA), or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions when executed by the processor 302 cause the UE 300 to perform various functions described herein. The code may be stored in a non-transitory computer-readable medium such as the memory 304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 302 and the memory 304 coupled with the processor 302 may be configured to cause the UE 300 to perform one or more of the functions described herein (e.g., executing, by the processor 302, instructions stored in the memory 304). For example, the processor 302 may support wireless communication at the UE 300 in accordance with examples as disclosed herein. The UE 300 may be configured to or operable to support a means for The UE 300 may be configured to or operable to support a means for communicating, to a network function, a session request message including a session identifier, a request type, and a support indication, receiving, from the network function, a response message including an acceptance indication, and establishing a secure connection with a UPF based on the acceptance indication. In this manner, the UE 300 enables simplified authentication mechanisms for multi-access sessions while maintaining compatibility with existing 5G security infrastructure, reducing connection establishment latency and computational overhead.

Additionally, or alternatively, the UE 300 may be configured to support any one or combination of the support indication indicates ATSSS capability with PSK support. This aspect enables the UE 300 to explicitly communicate its enhanced authentication capabilities to the network, ensuring proper selection of PSK-enabled network functions and preventing authentication failures during session establishment.

Additionally, or alternatively, the UE 300 may be configured to support any one or combination of deriving a security key prior to communicating the session request message or in response to receiving the response message. This aspect provides flexible key derivation timing that optimizes computational resources and enables the UE 300 to prepare authentication parameters when most efficient for the device's processing capabilities.

Additionally, or alternatively, the UE 300 may be configured to support any one or combination of establishing the secure connection with the UPF includes performing a TLS handshake and authentication procedure with the UPF using the security key and a temporary identifier, where the temporary identifier is a GUTI or a GPSI. This aspect leverages existing 5G identifier systems to provide secure authentication without requiring additional identity management infrastructure, reducing protocol complexity and maintaining interoperability.

Additionally, or alternatively, the UE 300 may be configured to support any one or combination of the security key is a pre-shared key. This aspect eliminates certificate management overhead and enables faster connection establishment by using symmetric key authentication, improving session setup performance and reducing computational requirements for secure MPQUIC connections.

Additionally, or alternatively, the UE 300 may support at least one memory (e.g., the memory 304) and at least one processor (e.g., the processor 302) coupled with the at least one memory and configured to cause the UE 300 to communicate, to a network function, a session request message including a session identifier, a request type, and a support indication, receive, from the network function, a response message including an acceptance indication, and establish a secure connection with a UPF based on the acceptance indication. In this manner, the UE 300 provides integrated hardware and software support for PSK-based authentication, enabling efficient multi-access session establishment with reduced authentication latency and improved connection reliability.

Additionally, or alternatively, the UE 300 may be configured to support any one or combination of the support indication indicates ATSSS capability with PSK support. This aspect ensures that the UE 300 processor can trigger appropriate authentication procedures based on network capabilities, optimizing security mechanisms for multi-access data transmission across multiple network paths.

Additionally, or alternatively, the UE 300 may be configured to support any one or combination of the at least one processor is operable to cause the UE 300 to derive a security key prior to communicating the session request message or in response to receiving the response message. This aspect enables the UE 300 to optimize key derivation timing based on processing load and network conditions, improving overall system efficiency and reducing authentication delays.

Additionally, or alternatively, the UE 300 may be configured to support any one or combination of to establish the secure connection with the UPF, the at least one processor is operable to cause the UE 300 to perform a TLS handshake and authentication procedure with the UPF using the security key and a temporary identifier, where the temporary identifier is a GUTI or a GPSI. This aspect enables the UE 300 to utilize standardized TLS procedures with PSK authentication, maintaining protocol compliance while achieving simplified certificate-free authentication for MPQUIC connections.

Additionally, or alternatively, the UE 300 may be configured to support any one or combination of the security key is a pre-shared key. This aspect allows the UE 300 to establish secure connections without certificate validation overhead, reducing connection establishment time and enabling more efficient authentication for time-sensitive multi-access applications.

The controller 306 may manage input and output signals for the UE 300. The controller 306 may also manage peripherals not integrated into the UE 300. In some implementations, the controller 306 may utilize an operating system such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may include one or more receiver chains 310, one or more transmitter chains 312, or a combination thereof.

A receiver chain 310 may be configured to receive signals (e.g., control information, data, packets) over a wireless medium. For example, the receiver chain 310 may include one or more antennas to receive a signal over the air or wireless medium. The receiver chain 310 may include at least one amplifier (e.g., a low-noise amplifier (LNA)) configured to amplify the received signal. The receiver chain 310 may include at least one demodulator configured to demodulate the receive signal and obtain the transmitted data by reversing the modulation technique applied during transmission of the signal. The receiver chain 310 may include at least one decoder for decoding the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

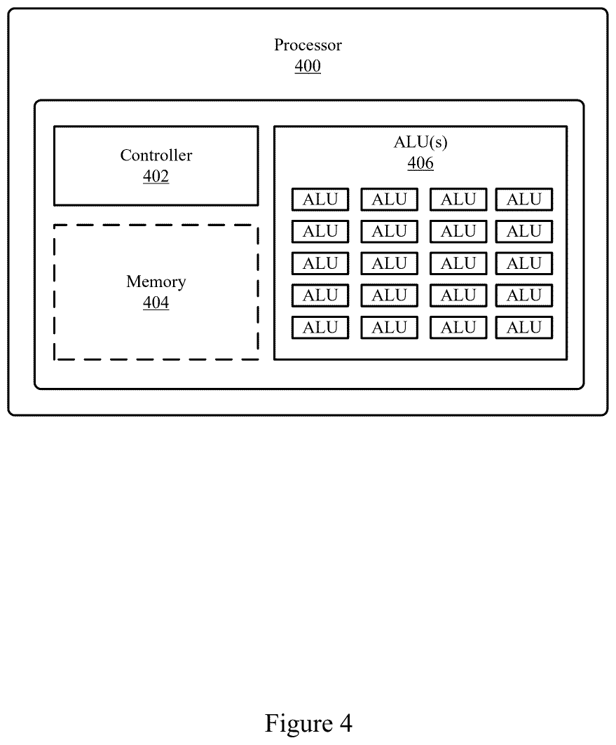

FIG. 4 illustrates an example of a processor 400 in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may optionally include at least one memory 404, which may be, for example, an L1/L2/L3 cache. Additionally, or alternatively, the processor 400 may optionally include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory addresses of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, ALUs 406, and other functional units of the processor 400.

The memory 404 may include one or more caches (e.g., memory local to or included in the processor 400 or other memory, such as RAM, ROM, DRAM, SDRAM, SRAM, MRAM, flash memory, etc. In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, and the controller 402, and may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 may be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

The processor 400 may support wireless communication in accordance with examples as disclosed herein. The processor 400 may be configured to or operable to support at least one controller (e.g., the controller 402) coupled with at least one memory (e.g., the memory 404) and configured to cause the processor to The processor 400 may be configured to or operable to support at least one controller (e.g., the controller 402) coupled with at least one memory (e.g., the memory 404) and configured to cause the processor to communicate, to a network function, a session request message including a session identifier, a request type, and a support indication, receive, from the network function, a response message including an acceptance indication, and establish a secure connection with a UPF based on the acceptance indication. In this manner, the processor 400 enables simplified authentication mechanisms for multi-access sessions while maintaining compatibility with existing 5G security infrastructure, reducing connection establishment latency and computational overhead.

Additionally, or alternatively, the processor 400 may be configured to support any one or combination of the support indication indicates ATSSS capability with PSK support. This aspect enables the processor 400 to explicitly communicate its enhanced authentication capabilities to the network, ensuring proper selection of PSK-enabled network functions and preventing authentication failures during session establishment.

Additionally, or alternatively, the processor 400 may be configured to support any one or combination of deriving a security key prior to communicating the session request message or in response to receiving the response message. This aspect provides flexible key derivation timing that optimizes computational resources and enables the processor 400 to prepare authentication parameters when most efficient for the device's processing capabilities.

Additionally, or alternatively, the processor 400 may be configured to support any one or combination of establishing the secure connection with the UPF includes performing a TLS handshake and authentication procedure with the UPF using the security key and a temporary identifier, where the temporary identifier is a GUTI or a GPSI. This aspect leverages existing 5G identifier systems to provide secure authentication without requiring additional identity management infrastructure, reducing protocol complexity and maintaining interoperability.

Additionally, or alternatively, the processor 400 may be configured to support any one or combination of the security key is a pre-shared key. This aspect eliminates certificate management overhead and enables faster connection establishment by using symmetric key authentication, improving session setup performance and reducing computational requirements for secure MPQUIC connections.

Additionally, or alternatively, the processor 400 may be configured to or operable to support at least one controller (e.g., the controller 402) coupled with at least one memory (e.g., the memory 404) and configured to cause the processor to receive, from a UE, a first request message including a session identifier, a request type, and a support indication, derive, in response to receiving the support indication, a security key, communicate, to a network function, a second request message including a temporary identifier, the support indication, and the security key, receive, from the network function, a first response message including an acceptance indication, and communicate, to the UE, a second response message including the acceptance indication. In this manner, the processor 400 provides centralized security key derivation and distribution, ensuring consistent authentication parameters across network functions and reducing computational overhead at UE devices.

Additionally, or alternatively, the processor 400 may be configured to support any one or combination of the support indication indicates ATSSS capability with PSK support. This aspect enables the processor 400 to trigger appropriate security key derivation procedures based on UE capabilities, optimizing authentication mechanisms for multi-access sessions.

Additionally, or alternatively, the processor 400 may be configured to support any one or combination of the acceptance indication indicates PSK-based authentication or certificate-based authentication. This aspect provides flexible authentication method selection based on network function capabilities, ensuring successful session establishment regardless of UPF authentication support.

Additionally, or alternatively, the processor 400 may be configured to support any one or combination of the first request message is for a PDU session, the request type is an MA PDU request type, the security key is a UPF security key, the network function is an SMF, and the temporary identifier is a GUTI or a GPSI. This aspect leverages existing 5G session management procedures and identifiers, minimizing protocol modifications while enabling PSK-based authentication for multi-access sessions.

Additionally, or alternatively, the processor 400 may be configured to support any one or combination of the first request message is received as part of a PDU session establishment procedure for establishing a multi-access PDU session supporting ATSSS. This aspect integrates PSK authentication capabilities into standard session establishment flows, maintaining protocol consistency and reducing implementation complexity.

Additionally, or alternatively, the processor 400 may be configured to support any one or combination of using a KDF with input parameters including at least one of a PDU session identifier, a NAS uplink COUNT value, an MA PDU session identifier, an IP address of the MA PDU session, a SUPI, a SUCI, a GUTI, a GPSI, an AMF key, or a SEAF key. This aspect ensures cryptographically secure key derivation using established 5G security parameters, maintaining security strength while enabling PSK-based authentication.

Additionally, or alternatively, the processor 400 may be configured to or operable to support at least one controller (e.g., the controller 402) coupled with at least one memory (e.g., the memory 404) and configured to cause the processor to receive, from a first network function, a first request message including a temporary identifier, a support indication, and a security key, communicate, to a second network function, a second request message including the temporary identifier, the support indication, and the security key, receive, from the second network function and in response to the second request message, a first response message including an acceptance indication, and communicate, to the first network function, a second response message including the acceptance indication. In this manner, the processor 400 enables efficient coordination of PSK-based authentication parameters between network functions, reducing signaling overhead and improving session establishment performance.

Additionally, or alternatively, the processor 400 may be configured to support any one or combination of the support indication indicates ATSSS capability with PSK support. This aspect enables the processor 400 to identify and process requests for enhanced multi-access connectivity with simplified authentication mechanisms, improving deployment flexibility.

Additionally, or alternatively, the processor 400 may be configured to support any one or combination of selecting the second network function based on the second network function being an ATSSS-enabled UPF that supports PSK. This aspect ensures optimal UPF selection for PSK-based sessions, preventing authentication failures and improving connection establishment reliability.

Additionally, or alternatively, the processor 400 may be configured to support any one or combination of the acceptance indication indicates PSK-based authentication or certificate-based authentication. This aspect provides backward compatibility with legacy systems while enabling enhanced PSK authentication for capable devices, maintaining network interoperability.

Additionally, or alternatively, the processor 400 may be configured to support any one or combination of the first network function is an AMF, the second network function is a UPF, the security key is a UPF security key, and the temporary identifier is a GUTI or a GPSI. This aspect leverages existing 5G network architecture and identifier systems, reducing implementation complexity and maintaining compatibility with established protocols.

Additionally, or alternatively, the processor 400 may be configured to support any one or combination of the second request message is an N4 session establishment request. This aspect utilizes standardized N4 interface procedures for UPF configuration, ensuring protocol compliance and interoperability with existing network infrastructure.

Additionally, or alternatively, the processor 400 may be configured to support any one or combination of the temporary identifier, the support indication, and the security key are received as part of a PDU session establishment procedure for a multi-access PDU session. This aspect integrates PSK authentication seamlessly into existing session establishment procedures, minimizing protocol modifications and reducing implementation overhead.

Additionally, or alternatively, the processor 400 may be configured to support any one or combination of activating MPQUIC functionality and deriving ATSSS rules and N4 rules for PDU session management. This aspect enables coordinated multi-path data transmission across different access networks, improving throughput and reliability for multi-access sessions.

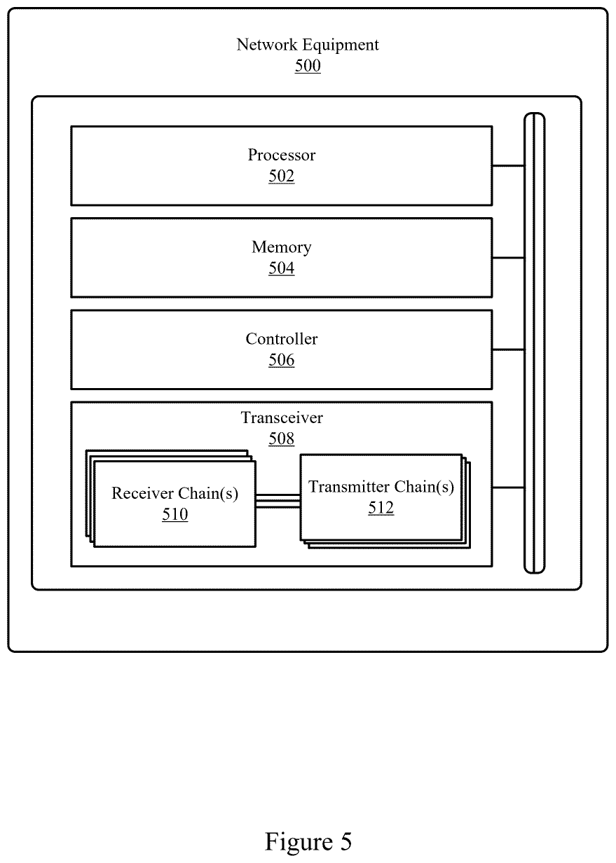

FIG. 5 illustrates an example of an NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure.

The memory 504 may include volatile or non-volatile memory. The memory 504 may store computer-readable, computer-executable code including instructions when executed by the processor 502 cause the NE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the functions described herein (e.g., executing, by the processor 502, instructions stored in the memory 504). For example, the processor 502 may support wireless communication at the NE 500 in accordance with examples as disclosed herein. The NE 500 may be configured to or operable to support a means for The NE 500 may be configured to or operable to support a means for receiving, from a first network function, a first request message including a temporary identifier, a support indication, and a security key, communicating, to a second network function, a second request message including the temporary identifier, the support indication, and the security key, receiving, from the second network function and in response to the second request message, a first response message including an acceptance indication, and communicating, to the first network function, a second response message including the acceptance indication. In this manner, the NE 500 enables efficient coordination of PSK-based authentication parameters between network functions, reducing signaling overhead and improving session establishment performance.

Additionally, or alternatively, the NE 500 may be configured to support any one or combination of the support indication indicates ATSSS capability with PSK support. This aspect enables the NE 500 to identify and process requests for enhanced multi-access connectivity with simplified authentication mechanisms, improving deployment flexibility.

Additionally, or alternatively, the NE 500 may be configured to support any one or combination of selecting the second network function based on the second network function being an ATSSS-enabled UPF that supports PSK. This aspect ensures optimal UPF selection for PSK-based sessions, preventing authentication failures and improving connection establishment reliability.

Additionally, or alternatively, the NE 500 may be configured to support any one or combination of the acceptance indication indicates PSK-based authentication or certificate-based authentication. This aspect provides backward compatibility with legacy systems while enabling enhanced PSK authentication for capable devices, maintaining network interoperability.

Additionally, or alternatively, the NE 500 may be configured to support any one or combination of the first network function is an AMF, the second network function is a UPF, the security key is a UPF security key, and the temporary identifier is a GUTI or a GPSI. This aspect leverages existing 5G network architecture and identifier systems, reducing implementation complexity and maintaining compatibility with established protocols.

Additionally, or alternatively, the NE 500 may be configured to support any one or combination of the second request message is an N4 session establishment request. This aspect utilizes standardized N4 interface procedures for UPF configuration, ensuring protocol compliance and interoperability with existing network infrastructure.

Additionally, or alternatively, the NE 500 may be configured to support any one or combination of the temporary identifier, the support indication, and the security key are received as part of a PDU session establishment procedure for a multi-access PDU session. This aspect integrates PSK authentication seamlessly into existing session establishment procedures, minimizing protocol modifications and reducing implementation overhead.

Additionally, or alternatively, the NE 500 may be configured to support any one or combination of activating MPQUIC functionality and deriving ATSSS rules and N4 rules for PDU session management. This aspect enables coordinated multi-path data transmission across different access networks, improving throughput and reliability for multi-access sessions.

Additionally, or alternatively, the NE 500 may support at least one memory (e.g., the memory 504) and at least one processor (e.g., the processor 502) coupled with the at least one memory and configured to cause the NE 500 to receive, from a UE, a first request message including a session identifier, a request type, and a support indication, derive, in response to receiving the support indication, a security key, communicate, to a network function, a second request message including a temporary identifier, the support indication, and the security key, receive, from the network function, a first response message including an acceptance indication, and communicate, to the UE, a second response message including the acceptance indication. In this manner, the NE 500 provides centralized security key derivation and distribution, ensuring consistent authentication parameters across network functions and reducing computational overhead at UE devices.

Additionally, or alternatively, the NE 500 may be configured to support any one or combination of the support indication indicates ATSSS capability with PSK support. This aspect enables the NE 500 to trigger appropriate security key derivation procedures based on UE capabilities, optimizing authentication mechanisms for multi-access sessions.

Additionally, or alternatively, the NE 500 may be configured to support any one or combination of the acceptance indication indicates PSK-based authentication or certificate-based authentication. This aspect provides flexible authentication method selection based on network function capabilities, ensuring successful session establishment regardless of UPF authentication support.

Additionally, or alternatively, the NE 500 may be configured to support any one or combination of the first request message is for a PDU session, the request type is an MA PDU request type, the security key is a UPF security key, the network function is an SMF, and the temporary identifier is a GUTI or a GPSI. This aspect leverages existing 5G session management procedures and identifiers, minimizing protocol modifications while enabling PSK-based authentication for multi-access sessions.

Additionally, or alternatively, the NE 500 may be configured to support any one or combination of the first request message is received as part of a PDU session establishment procedure for establishing a multi-access PDU session supporting ATSSS. This aspect integrates PSK authentication capabilities into standard session establishment flows, maintaining protocol consistency and reducing implementation complexity.

Additionally, or alternatively, the NE 500 may be configured to support any one or combination of using a KDF with input parameters including at least one of a PDU session identifier, a NAS uplink COUNT value, an MA PDU session identifier, an IP address of the MA PDU session, a SUPI, a SUCI, a GUTI, a GPSI, an AMF key, or a SEAF key. This aspect ensures cryptographically secure key derivation using established 5G security parameters, maintaining security strength while enabling PSK-based authentication.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., an LNA) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

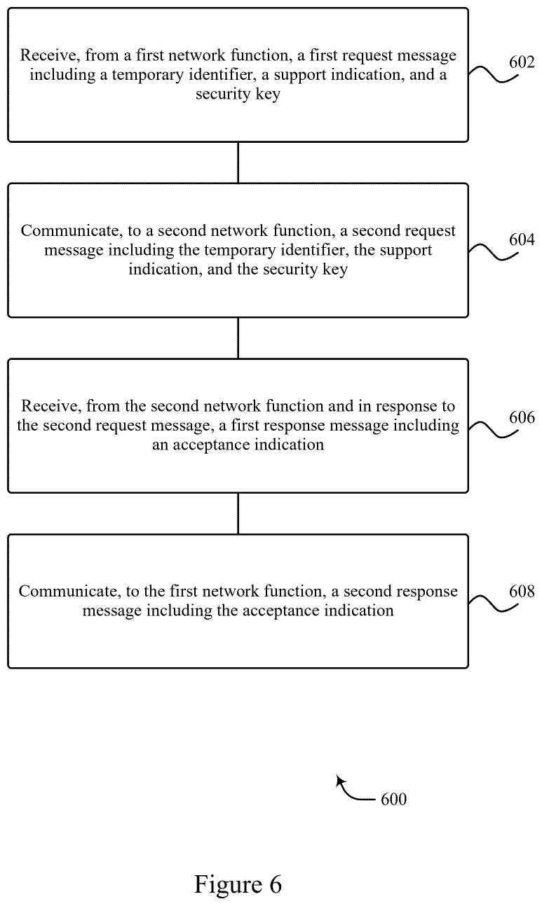

FIG. 6 illustrates a flowchart of a method 600 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 602, the method may include receiving, from a first network function, a first request message including a temporary identifier, a support indication, and a security key. The operations of 602 may be performed in accordance with examples as described herein. In some implementations, aspects of the operations of 602 may be performed by an NE as described with reference to FIG. 5.

At 604, the method may include communicating, to a second network function, a second request message including the temporary identifier, the support indication, and the security key. The operations of 604 may be performed in accordance with examples as described herein. In some implementations, aspects of the operations of 604 may be performed by an NE as described with reference to FIG. 5.

At 606, the method may include receiving, from the second network function and in response to the second request message, a first response message including an acceptance indication. The operations of 606 may be performed in accordance with examples as described herein. In some implementations, aspects of the operations of 606 may be performed by an NE as described with reference to FIG. 5.

At 608, the method may include communicating, to the first network function, a second response message including the acceptance indication. The operations of 608 may be performed in accordance with examples as described herein. In some implementations, aspects of the operations of 608 may be performed by an NE as described with reference to FIG. 5.

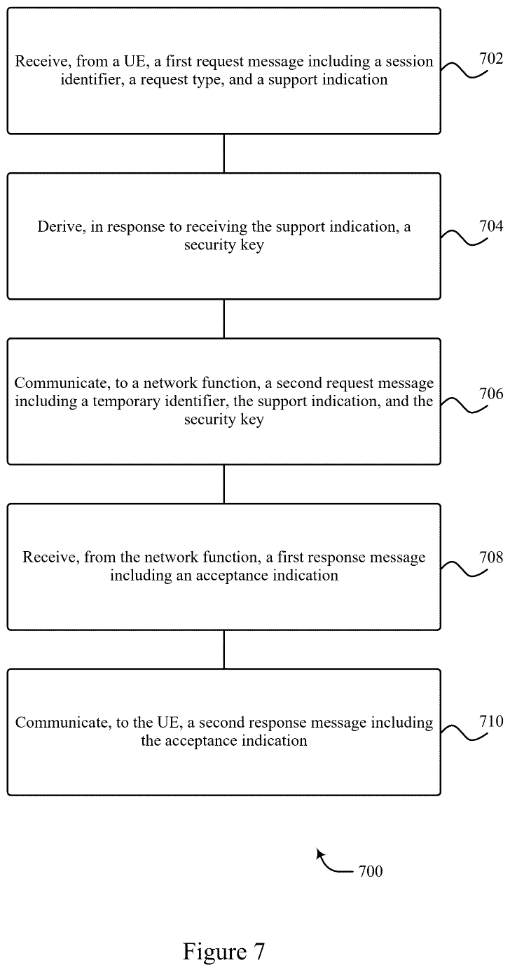

FIG. 7 illustrates a flowchart of a method 700 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 702, the method may include receiving, from a UE, a first request message including a session identifier, a request type, and a support indication. The operations of 702 may be performed in accordance with examples as described herein. In some implementations, aspects of the operations of 702 may be performed by an NE as described with reference to FIG. 5.

At 704, the method may include deriving, in response to receiving the support indication, a security key. The operations of 704 may be performed in accordance with examples as described herein. In some implementations, aspects of the operations of 704 may be performed by an NE as described with reference to FIG. 5.

At 706, the method may include communicating, to a network function, a second request message including a temporary identifier, the support indication, and the security key. The operations of 706 may be performed in accordance with examples as described herein. In some implementations, aspects of the operations of 706 may be performed by an NE as described with reference to FIG. 5.

At 708, the method may include receiving, from the network function, a first response message including an acceptance indication. The operations of 708 may be performed in accordance with examples as described herein. In some implementations, aspects of the operations of 708 may be performed by an NE as described with reference to FIG. 5.

At 710, the method may include communicating, to the UE, a second response message including the acceptance indication. The operations of 710 may be performed in accordance with examples as described herein. In some implementations, aspects of the operations of 710 may be performed by an NE as described with reference to FIG. 5.

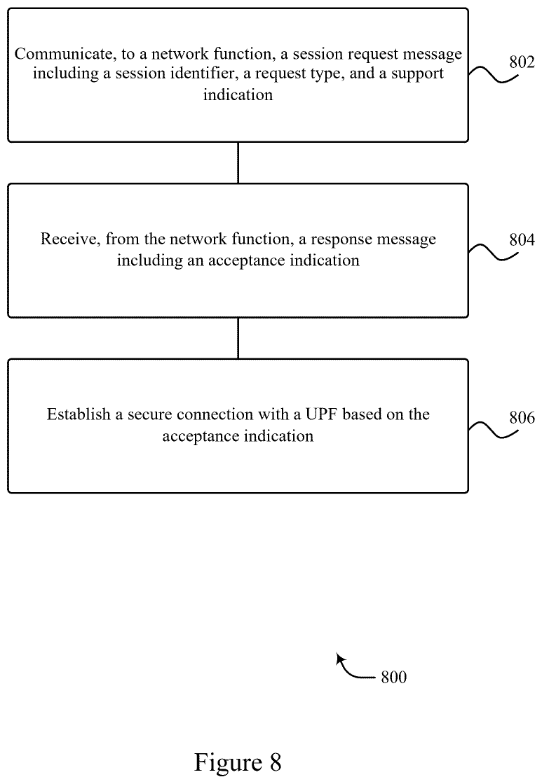

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include communicating, to a network function, a session request message including a session identifier, a request type, and a support indication. The operations of 802 may be performed in accordance with examples as described herein. In some implementations, aspects of the operations of 802 may be performed by a UE as described with reference to FIG. 3.

At 804, the method may include receiving, from the network function, a response message including an acceptance indication. The operations of 804 may be performed in accordance with examples as described herein. In some implementations, aspects of the operations of 804 may be performed by a UE as described with reference to FIG. 3.

At 806, the method may include establishing a secure connection with a UPF based at least in part on the acceptance indication. The operations of 806 may be performed in accordance with examples as described herein. In some implementations, aspects of the operations of 806 may be performed by a UE as described with reference to FIG. 3.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity (NE) for wireless communication, comprising:
at least one memory; and
at least one processor coupled with the at least one memory and operable to cause the NE to:
receive, from a first network function, a first request message including a temporary identifier, a support indication, and a security key;
communicate, to a second network function, a second request message including the temporary identifier, the support indication, and the security key;
receive, from the second network function and in response to the second request message, a first response message including an acceptance indication; and
communicate, to the first network function, a second response message including the acceptance indication.

2. The NE of claim 1, wherein the support indication indicates access traffic steering, switching, and splitting (ATSSS) capability with pre-shared key (PSK) support.

3. The NE of claim 2, wherein the at least one processor is further operable to cause the NE to select the second network function based at least in part on the second network function being an ATSSS-enabled user plane function (UPF) that supports PSK.

4. The NE of claim 2, wherein the acceptance indication indicates PSK-based authentication or certificate-based authentication.

5. The NE of claim 1, wherein the first network function is an access and mobility management function (AMF), the second network function is a user plane function (UPF), the security key is a UPF security key, and the temporary identifier is a globally unique temporary identifier (GUTI) or a generic public subscription identifier (GPSI).

6. The NE of claim 1, wherein the second request message is an N4 session establishment request.

7. The NE of claim 1, wherein the temporary identifier, the support indication, and the security key are received as part of a PDU session establishment procedure for a multi-access PDU session.

8. The NE of claim 7, wherein the at least one processor is further operable to cause the NE to:
activate multipath quick user datagram protocol (UDP) internet connections (MPQUIC) functionality; and
derive access traffic steering, switching, and splitting (ATSSS) rules and N4 rules for protocol data unit (PDU) session management.

9. A network entity (NE) for wireless communication, comprising:
at least one memory; and
at least one processor coupled with the at least one memory and operable to cause the NE to:
receive, from a user equipment (UE), a first request message including a session identifier, a request type, and a support indication;
derive, in response to receiving the support indication, a security key;
communicate, to a network function, a second request message including a temporary identifier, the support indication, and the security key;
receive, from the network function, a first response message including an acceptance indication; and
communicate, to the UE, a second response message including the acceptance indication.

10. The NE of claim 9, wherein the support indication indicates access traffic steering, switching, and splitting (ATSSS) capability with pre-shared key (PSK) support.

11. The NE of claim 10, wherein the acceptance indication indicates PSK-based authentication or certificate-based authentication.

12. The NE of claim 9, wherein the first request message is for a protocol data unit (PDU) session, the request type is a multi-access (MA) PDU request type, the security key is a user plane function (UPF) security key, the network function is a session management function (SMF), and the temporary identifier is a globally unique temporary identifier (GUTI) or a generic public subscription identifier (GPSI).

13. The NE of claim 9, wherein the first request message is received as part of a protocol data unit (PDU) session establishment procedure for establishing a multi-access PDU session supporting access traffic steering, switching, and splitting (ATSSS).

14. The NE of claim 9, wherein, to derive the security key, the at least one processor is further operable to cause the NE to use a key derivation function (KDF) with input parameters including at least one of a protocol data unit (PDU) session identifier, a non-access stratum (NAS) uplink COUNT value, a multi-access (MA) PDU session identifier, an internet protocol (IP) address of the MA PDU session, a subscription permanent identifier (SUPI), a subscription concealed identifier (SUCI), a globally unique temporary identifier (GUTI), a generic public subscription identifier (GPSI), an access and mobility management function (AMF) key, or a security anchor function (SEAF) key.

15. A user equipment (UE) for wireless communication, comprising:
at least one memory; and
at least one processor coupled with the at least one memory and operable to cause the UE to:
communicate, to a network function, a session request message including a session identifier, a request type, and a support indication;
receive, from the network function, a response message including an acceptance indication; and
establish a secure connection with a user plane function (UPF) based at least in part on the acceptance indication.

16. The UE of claim 15, wherein the support indication indicates access traffic steering, switching and splitting (ATSSS) capability with pre-shared key (PSK) support.

17. The UE of claim 15, wherein the at least one processor is further operable to cause the UE to derive a security key prior to communicating the session request message or in response to receiving the response message.

18. The UE of claim 17, wherein, to establish the secure connection with the UPF, the at least one processor is further operable to cause the UE to perform a transport layer security (TLS) handshake and authentication procedure with the UPF using the security key and a temporary identifier, wherein the temporary identifier is a globally unique temporary identifier (GUTI) or a generic public subscription identifier (GPSI).

19. The UE of claim 18, wherein the security key is a pre-shared key.

20. A method performed by a network entity (NE), the method comprising:
receiving, from a first network function, a first request message including a temporary identifier, a support indication, and a security key;
communicating, to a second network function, a second request message including the temporary identifier, the support indication, and the security key;
receiving, from the second network function and in response to the second request message, a first response message including an acceptance indication; and
communicating, to the first network function, a second response message including the acceptance indication.
